(19) United States
(12) Patent Application Publication
(10) Pub. No.: US 2022/0166708 A1
(43) Pub. Date: May 26, 2022

(54) METHOD AND APPARATUS FOR SELECTING PACKET PATH TO SUPPORT PRODUCER MOBILITY IN INFORMATION-CENTRIC NETWORKING

(71) Applicant: ELECTRONICS AND TELECOMMUNICATIONS RESEARCH INSTITUTE, Daejeon (KR)

(72) Inventor: Sung Hyuk Byun, Daejeon (KR)

(73) Assignee: ELECTRONICS AND TELECOMMUNICATIONS RESEARCH INSTITUTE, Daejeon (KR)

(21) Appl. No.: 17/533,104

(22) Filed: Nov. 22, 2021

(30) Foreign Application Priority Data
Nov. 26, 2020 (KR) 10-2020-0161476

(51) Int. Cl. H04L 45/30; H04L 45/02

(52) U.S. Cl. CPC H04L 45/30; H04L 45/02

(57) ABSTRACT

Disclosed herein are a packet path selecting method and apparatus in an information-centric network. A packet path selecting method performed by a terminal in an information-centric network includes obtaining information on a network connected with the terminal, transmitting a packet for intra-network path selecting to a node of the network, and receiving a reply packet for intra-network path selecting from the node. The packet for intra-network path selecting includes information on a previous network of the terminal and information on a current network of the terminal.

### CROSS REFERENCE TO RELATED APPLICATION

The present application claims priority to Korean Patent Application No. 10-2020-0161476 filed Nov. 26, 2020, the entire contents of which is incorporated herein for all purposes by this reference.

### BACKGROUND OF THE INVENTION

### 1. Field of the Invention

The present disclosure relates to a method and apparatus for selecting a packet path in an information-centric network and, more particularly to technology for selecting an appropriate packet path to support inter-network mobility of a producer terminal.

### 2. Description of the Related Art

Currently, the scale of a data service on the Internet is rapidly increasing. Meanwhile, the current Internet is operating using an IP address. A data requestor, that is, a consumer, may request and receive data using only an IP address. When at least one or more users who request the same data is present on a network, since data needs to be repeatedly transmitted as many as the number of users, it may be inefficient in terms of repeated data transmission.

In order to solve this, recently, research into and development of an information-centric networking structure as a replacement of an IP-based network structure are being actively conducted. The information-centric network (networking) of the present disclosure includes a content-based/centric network, information-based/centric network, a content-centric networking (CCN), an information-centric networking (ICN) and a named data networking (NDN).

In a network supporting information-centric technology, the concept of an information publisher or producer who generates data and an information consumer who receives and consumes data may be introduced instead of a transceiver, such that the network may perform routing using information names instead of IP addresses. Routers may use methods of storing specific data if necessary and distributing data to nearby new consumers who request data.

In the information-centric network, when an interest packet in which a data name requested by an information consumer is included in a header is transmitted, a node corresponding to an information provider who caches or owns data may respond as a data packet through data name-based forwarding. In this case, the data packet may be transmitted to a data requestor along a path, through which the interest packet is transmitted. Meanwhile, a node configuring the information-centric network may include a content store (CS) which caches a data packet which has passed through the corresponding node, a forwarding information base (FIB) for forwarding an interest packet based on the data name, and a pending interest table (PIT) which stores and manages information on the interest packet, to which response has not been received.

The information-centric network has a strength in that mobility of a terminal may be supported compared to the address-based IP network. As an example, when a data provider (producer) is a fixed server and a data requestor (consumer) moves, the requestor may retransmit the interest packet whenever a connected network is changed, such that mobility of the requestor terminal may be naturally supported by an exchange method of the interest packet/data packet in the information-centric network. However, when the data producer moves and thus the connected network changes, a method of selecting a packet path to support mobility of the producer terminal may be problematic.

### SUMMARY OF THE INVENTION

An object of the present disclosure is to provide packet path selecting technology capable of supporting mobility of a producer.

Another object of the present disclosure is to provide packet path selecting technology capable of minimizing service interruption when a connected network of a data producer is changed.

Another object of the present disclosure is to provide packet path selecting technology capable of reducing path selection prefix related overhead by selecting a prefix according to a rendezvous node.

Another object of the present disclosure is to provide packet path selecting technology capable of supporting mobility of a data producer without name resolution server (NRS) lookup of a data requestor.

Other objects and advantages of the present disclosure may be understood by the following description, and will become more clearly understood by the embodiments of the present disclosure. Further, it will be readily apparent that the objects and advantages of the present disclosure may be realized by the means of claims and combinations thereof.

A packet path selecting method performed by a terminal in an information-centric network according to an embodiment of the present disclosure includes obtaining information on a network connected with the terminal, transmitting a packet for intra-network path selecting to a rendezvous node of the connected network, and receiving a reply packet for intra-network path selecting from the rendezvous node. The packet for intra-network path selecting includes information on a previous network of the terminal and information on a current network of the terminal.

Meanwhile, the packet for intra-network path selecting may include a rendezvous node prefix.

Meanwhile, the rendezvous node prefix may be advertised to a routing protocol of the network connected with the terminal.

Meanwhile, the packet for intra-network path selecting may be periodically transmitted.

Meanwhile, network movement of the terminal may be updated to a name resolution server (NRS).

A packet path selecting method performed by a rendezvous node in an information-centric network according to an embodiment of the present disclosure includes receiving a packet for intra-network path selecting from a terminal connected to a network of the rendezvous node, and transmitting a reply packet for intra-network path selecting to the terminal. Upon determining that network movement of the terminal has occurred, transmitting a packet for inter-network path selecting to a rendezvous node of a previous network of the terminal.

Meanwhile, the packet for intra-network path selecting and the inter-network path selecting may include a rendezvous node prefix.

Meanwhile, the rendezvous node prefix may be advertised to a routing protocol of the network of the rendezvous node.

Meanwhile, network movement of the producer terminal may be determined by comparing the information on the previous network included in the received packet with the information on the current network.

Meanwhile, the packet path selecting method may further include receiving a reply packet for inter-network path selecting from the previous network node of the terminal, upon determining that network movement of the terminal has occurred.

A packet path selecting method performed by a network node in an information-centric network according to an embodiment of the present disclosure includes delivering a packet for path selecting between a data owner and a data requestor, and delivering a reply packet for path selecting between a data owner and a data requestor. The packet for path selecting may include a packet for intra-network path selecting and a packet for inter-network path selecting according to network movement of the data owner.

Meanwhile, network movement of the data owner may be determined by comparing information on a previous network of the packet for intra-network path selecting with information on a current network.

Meanwhile, the reply packet for path selecting may include a reply packet for intra-network path selecting and a reply packet for inter-network path selecting according to network movement of the data owner.

Meanwhile, the reply packet for intra-network path selecting and the reply packet for inter-network path selecting may be managed as forwarding information base (FIB) entries based on the same path selection prefix (trace prefix).

Meanwhile, when the reply packet for path selecting is a reply packet for inter-network path selecting and there is no destination network name in a pending interest table (PIT) entry matching the packet, this may mean that the network node exists in a previous network of the data owner.

Meanwhile, when the reply packet for path selecting is a reply packet for inter-network path selecting and there is a destination network name in a pending interest table (PIT) entry matching the packet, this may mean that the network node exists in a current network of the data owner or a third-party network.

Meanwhile, when the network node exists in a previous network of the data owner, nexthop priority of the reply packet for intra-network path selecting may be lower than that of the reply packet for inter-network path selecting.

Meanwhile, when the network node exists in a current network of the data owner, nexthop priority of the reply packet for intra-network path selecting may be higher than that of the reply packet for inter-network path selecting.

Meanwhile, the reply packet for path selecting may be delivered to an incoming interface of the packet for path selecting included in a matching PIT entry.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a rendezvous node (RV) and path trace technology for supporting mobility of a producer in an information-centric network applicable to the present disclosure;

FIG. 2 is a view illustrating a packet format which may be used when tracing a path to support mobility of a producer in an information-centric network applicable to the present disclosure;

FIG. 3 is a view illustrating packet path selecting technology for supporting mobility of a producer in an information-centric network proposed by the present disclosure;

FIG. 4 is a view illustrating a packet format which may be used when selecting a packet path to support mobility of a producer in an information-centric network according to an embodiment of the present disclosure;

FIG. 5 is a view illustrating a packet path selecting method performed by a rendezvous node (RV) in an information-centric network according to an embodiment of the present disclosure;

FIG. 6 is a view illustrating a packet path selecting method performed by an information-centric network (ICN) node in an information-centric network according to an embodiment of the present disclosure;

FIG. 7 is a view illustrating a structure of a node in an information-centric network according to an embodiment of the present disclosure;

FIG. 8 is a view illustrating a packet path selecting apparatus in an information-centric network according to an embodiment of the present disclosure;

FIG. 9 is a view illustrating a packet path selecting method of a terminal in an information-centric network according to an embodiment of the present disclosure;

FIG. 10 is a view illustrating a packet path selecting method of a rendezvous node in an information-centric network according to an embodiment of the present disclosure;

FIG. 11 is a view illustrating a packet path selecting method of a rendezvous node in an information-centric network according to another embodiment of the present disclosure; and

FIG. 12 is a view illustrating a packet path selecting method of an ICN node in an information-centric network according to an embodiment of the present disclosure.

### DESCRIPTION OF THE PREFERRED EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. In the drawings, portions which are not related to the description of the present disclosure will be omitted and similar portions are denoted by similar reference numerals in the entire specification.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present disclosure, terms such as first, second, etc. are used only for the purpose of distinguishing one component from other components, and unless otherwise specified, the order or importance between the components is not limited. Accordingly, within the scope of the present disclosure, a first component in one embodiment may be referred to as a second component in another embodiment, and similarly, a second component in one embodiment is referred to as a first component in another embodiment.

In the present disclosure, when an element is simply referred to as being “connected to” or “coupled to” another element, this may mean that an element is “directly connected to” or “directly coupled to” another element or is connected to or coupled to another element with the other element intervening therebetween. In contrast, it should be understood that when an element is referred to as being “directly coupled” or “directly connected” to another element, there are no intervening elements present.

Meanwhile, in the present disclosure, path selection may include path trace.

Meanwhile, in the present disclosure, delivery may include reception and transmission.

Meanwhile, in the present disclosure, a data producer may be used interchangeably with a data owner and a producer and a data consumer may be used interchangeably with a data requestor and a consumer. In addition, the data producer may mean a data producer terminal and the data consumer may mean a data consumer terminal.

Meanwhile, in the present disclosure, an information-centric network (networking) may include a content-based/centric network, an information-based/centric network, a content-centric networking (CCN), an information-centric networking (ICN), and a named data networking (NDN).

Meanwhile, in the present disclosure, an ICN node, a network node and a connection node may be used interchangeably and may mean a node other than a rendezvous node. The ICN node (connection node) may include a router, an access point, etc.

Meanwhile, in the present disclosure, a rendezvous node (RV) may refer to a node which advertises a rendezvous node prefix which is a routing prefix to a routing protocol on behalf of a data owner. In this case, the name “rendezvous node” may be an arbitrary name and may be referred to as another name.

Meanwhile, in the present disclosure, an interest packet includes a packet for path selecting and an interest packet for a data request, and the data packet may include a reply packet for path selecting and a data packet which is a reply packet to the data request.

Meanwhile, in the present disclosure, a packet for path selecting may include a packet for intra-network path selecting and a packet for inter-network path selecting. In addition, the reply packet for path selecting may include a reply packet for intra-network path selecting and a reply packet for inter-network path selecting. In this case, the packet for path selecting may be a path trace interest packet, and the reply packet for path selecting may be a path trace data packet.

Meanwhile, in the present disclosure, a terminal may include a data owner and a data requestor.

In addition, in the present disclosure, unless one drawing showing an embodiment of the present disclosure corresponds to an alternative embodiment, the description of each drawing is applicable to different drawings.

Hereinafter, the present disclosure will be described in greater detail with reference to the drawings.

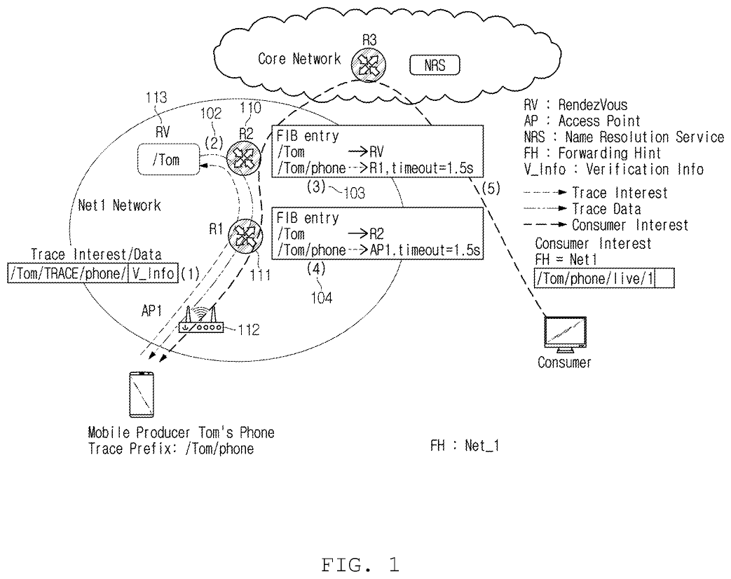

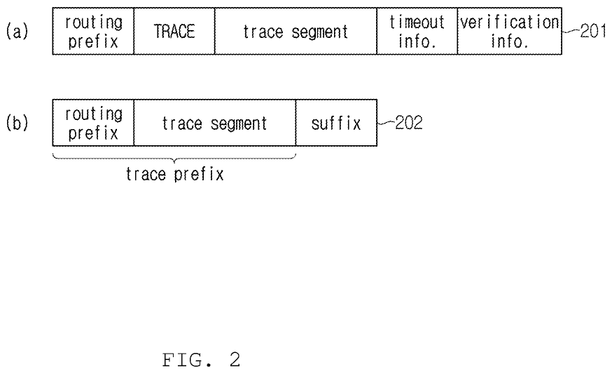

FIG. 1 is a view illustrating a rendezvous node (RV) and path selecting (path trace) technology for supporting mobility of a producer in an information-centric network applicable to the present disclosure, and FIG. 2 is a view illustrating a packet format which may be used when tracing a path to support mobility of a producer in an information-centric network applicable to the present disclosure.

More specifically, FIG. 2 is a view illustrating a format of a packet for path selecting (trace interest packet), a reply packet for path selecting (trace data packet) and an interest packet when a data requestor requests data from a data owner, based on the path selecting technology of FIG. 1.

In the information-centric network, in the case of network movement of the data owner, in order to deliver an interest packet transmitted by the data requestor to the mobile data owner, path selection, that is, a path trace method, based on a rendezvous node of FIG. 1 may be used.

FIG. 1 is a view illustrating a data owner mobility support structure based on a packet for packet selecting and a reply packet for path selecting (trace interest packet/trace data packet) and a rendezvous node RV 113. The rendezvous node RV 113 refers to a node which may advertise “/Tom” which is a routing prefix to a routing protocol on behalf of Tom who a mobile data producer, and may define an intra-network path and an inter-network path of a packet. In addition, one rendezvous node may exist in each network, but multiple rendezvous nodes may exist in implementation. Meanwhile, Tom who is the data owner may periodically transmit a packet for path selecting, that is, a path trace interest packet, to the rendezvous node, in order to define a packet path from the rendezvous node 113 to Tom who is the data owner for “Tom/phone” which is a path selection prefix (trace prefix).

Meanwhile, as shown in a a) of FIG. 2, a path trace interest packet 201 which is a packet for path selecting may have a name starting with a routing prefix (“/Tom”) advertised by the rendezvous node RV, and may include a TRACE tag indicating that a current packet is a packet for path selecting, a path selection segment (trace segment) (“/phone”) excluding a routing prefix (“/Tom”) from the path selection prefix (tray trace prefix) (“/Tom/phone”), and timeout time information related to the lifetime of the packet path. Verification information for proving that the packet for path selecting has been transmitted from the data owner may also be included. For example, the verification information may include a production time of a packet for selecting a current path (trace interest packet), a nonce which is a random value, and signature information for preventing forgery and falsification.

In addition, an interest packet 202 transmitted when the data requestor requests data from the data owner may be as shown in b) of FIG. 2 and may include a routing prefix, a path selection segment (trace segment) and a suffix. In this case, the routing prefix and the path selection segment may be referred to as trace prefix.

Meanwhile, when the mobile data owner transmits a packet for path selecting to the rendezvous node, an ICN node such as a pass-through router routes and forwards it in the same manner as an interest packet for a general data request and thus store information for a packet for path selecting in a pending interest table (PIT). This may correspond to procedures 1 and 101 of FIG. 1. When the packet for path selecting arrives at the rendezvous node through pass-through ICN nodes AP1, R1 and R2, the rendezvous node may verify a packet for normal path selecting (trace interest packet) based on the verification information and output and transmit a reply packet for path selecting (trace data packet). This may correspond to procedures 2 and 102 of FIG. 1.

The pass-through ICN nodes R2 110, R1 111 and AP1 112, which have received the reply packet for path selecting (trace data packet), may determine that a current packet is a reply packet for path selecting, when there is an entry matching each pending interest table (PIT) and a “TRACE” tag of the received reply packet is included in a name. Accordingly, a path selection prefix “/Tom/phone” may be extracted from the reply packet for path selecting and may be created as a new entry of a forwarding information base (FIB) or may be updated to an existing entry. In this case, nexthop for a next path through which shall pass in order to deliver the reply packet for path selecting from the ICN node to the data owner may be set based on an incoming interface of a matching PIT entry. In this case, the incoming interface may be an incoming interface for a packet for path selecting. As the incoming interface is configured, since a path between the data owner and the data request may be constantly regenerated, the timeout information for path selecting may also be set.

Meanwhile, the FIB of R2 110 which is the ICN node may include only the routing prefix (“/Tom”) entry initially advertised by the rendezvous node 113. In this case, as the reply packet for path selecting is received and processed in procedures 3 and 103, “/Tom/phone” which is a path selection prefix (trace prefix) may be added to the FIB, and a next ICN node according to the incoming interface of nexthop may be set to R1 111. That is, the nexthop may include incoming interface information when the packet for path selecting is delivered from R1 111 to R2 110.

In an embodiment, the FIB entry after processing the reply packet for path selecting in R1 111 may be equal to that in the procedures 4 and 104. Therefore, the reply packet for path selecting may be ultimately transmitted to Tom who is a mobile data owner, and a path for sending, to the mobile data consumer, the interest packet of the data consumer corresponding to the path selection prefix (trace prefix) between the rendezvous node and the mobile data consumer may be defined by the reply packet for path selecting. In this case, the defined path is not fixed and may be changed with time, and the packet for path selecting may be periodically transmitted by the mobile data owner and thus the path may also be periodically created and changed.

A data requestor who requests the data of the mobile data owner based on the path defined in the above procedures may generally look up a desired data name based on a name resolution server (NRS) located in a core network, and then obtain network information including information on a network in which the data owner having the data exists. The data requestor may transmit the network information including the data name and the network information to the data owner according to a destination network name of the interest packet. In an embodiment, the destination network name may be transmitted to the data owner in a forwarding hint (FH) field. It is assumed that the data requestor requests data “/Tom/phone/live/1” having a prefix “/Tom/phone”, and the NRS may confirm that the corresponding data is located in Net1 network in which the data owner exits and then the destination network name (e.g., the forwarding hit (FH) field) may be set to Net1. The interest packet is set to FH=Net1 and delivered to the Net1 network, and the path selection prefix (trace prefix) registered in the FIB of each of R2 110, R1 111 and AP1 112 may be delivered to the data owner by an entry “Tom/phone”.

Meanwhile, the procedures described above may properly support mobility of the data owner within one network as long as the connected network is not changed even if the data owner moves. However, it may be difficult to support movement of data owner based on multiple networks, that is, movement of the data owner to a network managed by another rendezvous node. The rendezvous node shall advertise the routing prefix of the data owner to the routing protocol in advance. However, it may be difficult to know a network, to which the data owner moves, in advance before the data owner moves to another network and advertise the routing prefix to the rendezvous node. Accordingly, after the data owner moves to the new network, the rendezvous node prefix shall be advertised to the routing protocol. However, as the network connected with the data owner is changed, connection interruption may occur due to a routing setting request and a packet propagation time. In addition, unless the data requestor recognizes network movement of the data owner by re-search (re-lookup) based on the NRS, since the data requestor continues to transmit the interest packet to the previous network, the packet is forwarded to the previous network. Therefore, it may be difficult to deliver the packet to the new network.

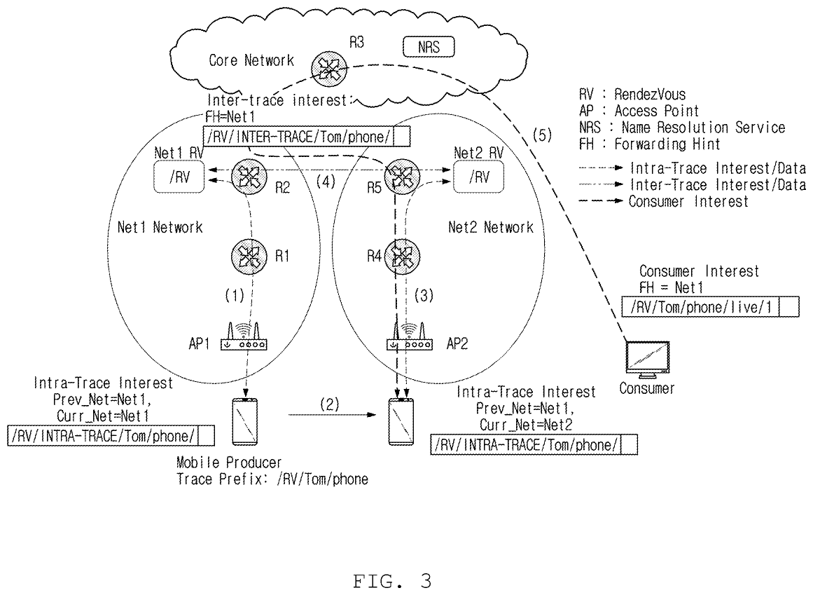

Accordingly, in the present disclosure, packet path selection technology for supporting mobility of a data owner based on distributed rendezvous nodes, which can minimize service interruption even when a mobile data owner moves between networks managed by different rendezvous nodes, will be proposed as several embodiments with reference to FIGS. 3 to 12.

Meanwhile, as an embodiment, even in FIGS. 3 to 12 of the present disclosure, the procedures of FIGS. 1 and 2 may be performed in the procedure for intra-network path selection and when a terminal moves only in one network (the connected network is not changed).

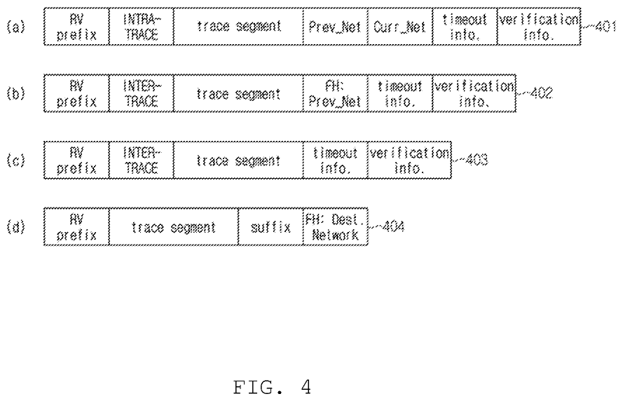

FIG. 3 is a view illustrating packet path selection technology for supporting mobility of a producer in an information-centric network proposed by the present disclosure, and FIG. 4 is a view illustrating a packet format which may be used when selecting a packet path to support mobility of a producer in an information-centric network according to an embodiment of the present disclosure. More specifically, these are drawings illustrating the format of a packet for intra-network path selection and inter-network path selection (interest packet for path selection), a reply packet for path selection (data packet for path selection) and an interest packet of a data requestor.

More specifically, according to an embodiment of the present disclosure, when a mobile data owner moves to a new network managed by another rendezvous node, a path for re-routing, to the network newly connected with the data owner, interest packets continuously sent by a data requestor who does not know it may be defined. This path selection process may be based on exchange of a packet for inter-network path selection and a reply packet for inter-network path selection (inter-trace interest packet/data packet). The path selection procedure in the network may be as described above and may be expressed by intra-trace selection.

Prior to description of an embodiment of the present disclosure with reference to FIGS. 3 to 4, for clarity of description, it is assumed that a data owner and a data requestor are connected to different networks and the data owner may be a mobile data owner. In addition, as described above, a rendezvous node may exist in each network. It is assumed that the data requestor may transmit an interest packet for requesting data to the data owner and the data owner may transmit a packet for path selecting in advance to support mobility of a terminal. This packet may be periodically transmitted.

In an embodiment, a terminal of Tom who is a data owner moves from Net1 network to Net2 network to be connected to the Net2 network and transmits a packet for path selecting. This packet is transmitted to the rendezvous node of Net2 through an ICN node including AP2, R4 and R5. The rendezvous node may confirm that the data owner has moved between networks based on information on a previous network of the packet and information on a current network, transmit a packet for inter-network path selecting to the rendezvous node of the previous network (Net1), and transmit a reply packet for intra-network path selecting to the data owner. The rendezvous node of the previous network (Net1) may transmit a reply packet for inter-network path selecting back to the rendezvous node of the current network.

The interest packet for path selecting described above may have formats of a) and b) of FIG. 4. More specifically, a packet and reply packet for intra-network path selecting may be 401 of a) of FIG. 1 and a packet for inter-network path selecting may be 402 of b) of FIG. 4. The reply packet for inter-network path selecting may be represented by 403 of c) of FIG. 4 and the interest packet of the data requestor may be represented by 404 of d) of FIG. 4. However, this is an embodiment and the format of the packet is not limited to FIG. 4 and the sizes and order of fields may be changed, some fields may be removed or other fields may be added. In addition, each packet format of FIG. 4 is applicable to a packet having the same name described in the present disclosure. In an embodiment, the routing prefix of the packet described with reference to FIGS. 1 and 2 may be expressed as a common rendezvous node (RV) prefix. In addition, the path selection (trace) tag of FIGS. 1 and 2 may be expressed as a tag indicating whether it is intra-network path selection or inter-network path selection. In addition, as shown in b) of FIG. 2, a combination of the routing prefix or the rendezvous node prefix and the path selection (trace) segment may be expressed as the trace prefix, which may be expressed as the data prefix of the data owner.

The packet and reply packet 401 for intra-network path selection may include a rendezvous node prefix, a tag indicating a packet for intra-network path selection, a path selection segment, a previously connected network name and currently connected network name of a terminal, and timeout information and verification information of a path. The description of the timeout information and verification information and the path selection segment field may be equal to the description of FIG. 2.

In an embodiment, the rendezvous node prefix may correspond to a routing prefix. For each rendezvous node, when the data owner visits the corresponding network, the routing prefix of the data owner may be set in advance. Therefore, when the data owner rapidly moves among various networks while changing connection to multiple networks, an unnecessary pre-setting process to the rendezvous node may occur. The rendezvous node prefix may prevent this. Accordingly, in order to eliminate such overhead, the data prefix of the data owner may start with a common rendezvous node prefix. For example, the data names of all data owners may have a common rendezvous node prefix of /RV. In order to support mobility of the data owner based on the distributed rendezvous node, by allocating a unique name space at less than /RV/ which is the rendezvous node prefix, it is possible to eliminate complexity occurring when advertising the routing prefix of the data owner for each rendezvous node. That is, instead of the routing prefix of each data owner, only /RV may be advertised. In addition, since the rendezvous node of each network advertises only the common rendezvous node prefix to the routing protocol, overhead is also significantly reduced. Meanwhile, this is only an embodiment of the present disclosure, and thus this prefix may be determined in advance by the international standard organization for the distributed rendezvous node structure when allocating a global name space in the information-centric network and may have a different name.

In an embodiment, when connecting to a wireless network, the data owner may obtain the name of the connected network from a connected node. Thereafter, as shown in an example shown in a) of FIG. 4, the data owner may include information on a previous network and information on a current network including Prev_Net which is a previously connected network name and Curr_Net which is a newly connected network name in a packet for intra-network path selection (intra-trace interest). In an embodiment, a new network rendezvous node, which has received the packet for intra-network path selection, may recognize movement from the previously connected network (Prev_Net) to the network thereof and transmit the packet for inter-network path selection (inter-trace interest) to the rendezvous node (Prev_Net RV) of the previously connected network, when the previously connected network name included in the packet is not equal to the newly connected network name (Prev_Net !=Curr_Net).

More specifically, in an embodiment, Net2 RV which is the rendezvous node of the new network may transmit the packet for inter-network path selection (Inter-Trace Interest packet) to the rendezvous node (Net1 RV) of the previous network. Int this case, the rendezvous node (Net1 RV) of the previous network, which has received this, may return a reply packet for inter-network path selection (Inter-Trace Data packet). Accordingly, an inter-network path for the path selection prefix of the mobile data owner may be defined as a path from the rendezvous node of the previous network to the rendezvous node of the new network. The rendezvous node of the previous network receiving the packet for inter-network path selection and returning the reply packet for inter-network path selection to the rendezvous node of the new network may be performed in the same manner as the operation of processing the packet for path selection (trace Interest packet) in the rendezvous node as described above.

After an inter-network path is defined, even if the data requestor continues to transmit the interest packet to the network Net1 where the data owner previously existed without performing NRS re-lookup, the interest packet may be re-routed from the ICN node (e.g., Net1 R2) of the previous network to the ICN node (Net2 R3) of the new network through the inter-network path and may be successfully delivered to the mobile data owner through the path defined in the network of the new network Net2. Accordingly, the data requestor may seamlessly receive desired data.

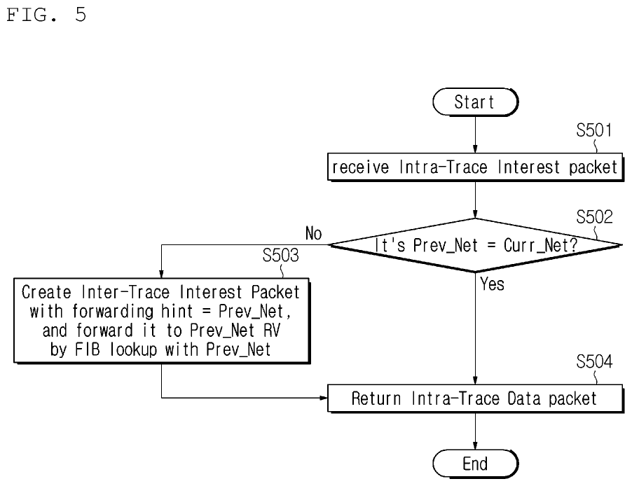

FIG. 5 is a view illustrating a packet path selection method performed by a rendezvous node according to an embodiment of the present disclosure. More specifically, this is a view illustrating a method of performing intra-network path selection and inter-network path selection when the rendezvous node receives an interest packet for path selection.

In an embodiment, the packet for path selection and the reply packet for path selection of FIG. 5 may have the packet format described with reference to FIG. 4.

In an embodiment, the rendezvous node may correspond to a newly connected network, that is, a rendezvous node of a network to which a terminal is currently connected. The rendezvous node may first receive a packet for intra-network path selecting (S501). The packet may be transmitted by a mobile data owner.

After receiving the packet, the rendezvous node may compare information on a previous network included in the packet with information on a new network (S502), in order to determine whether inter-network movement of a terminal which has transmitted the packet for intra-network path selecting has occurred.

In an embodiment, when the previously connected network name included in the packet is not equal to the newly connected network name (Prev_Net !=Curr_Net) (S503), the rendezvous node of the new network may create and transmit a packet for inter-network path selecting to the rendezvous node of the previous network while transmitting the reply packet for intra-network path selecting to the terminal. In this case, a destination network name (e.g., a forwarding hint) of the packet for inter-network path selecting may be set to the previous network (Prev_Net), and this packet may be transmitted to the rendezvous node of the previous network, by performing FIB lookup based on the previous network name (Prev_Net).

Meanwhile, when the previously connected network name included in the packet is equal to the newly connected network name (Prev_Net=Curr_Net) (S504), since it may be interpreted that inter-network movement of the terminal does not occur, the rendezvous node of the current network may not transmit the packet for inter-network path selecting. Accordingly, only a reply packet for intra-network path selecting may be transmitted in response to the packet for intra-network path selecting of the terminal.

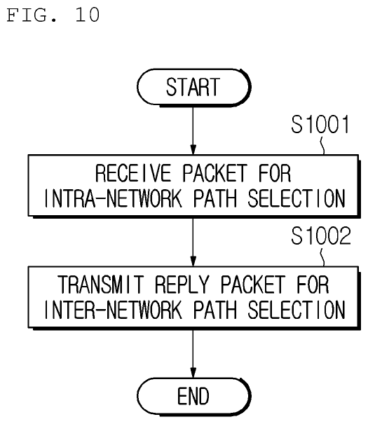

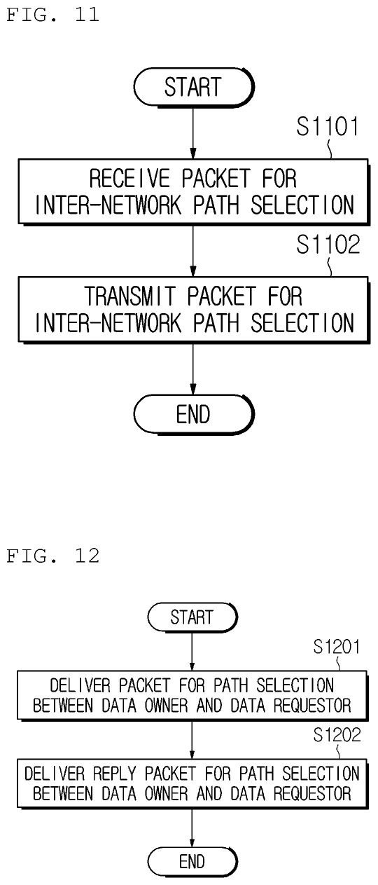

Meanwhile, the packet path selecting method of FIG. 5 may be divided into a method performed by the rendezvous node of the current network and a method performed by the rendezvous node of the previous network, which will be described below in greater detail with reference to FIGS. 10 and 11.

FIG. 6 is a view illustrating a packet path selecting method performed by an information-centric network (ICN) node in an information-centric network according to an embodiment of the present disclosure.

According to the packet path selecting technology in the information-centric network according to an embodiment of the present disclosure, the defined inter-network path and the defined intra-network path may have the same path according to network topology. That is, an overlapping path such as passing through the same ICN node may be included. In an embodiment, FIG. 3 described above includes this case. According to FIG. 3, the data owner may be connected to the Net1 network, and intra-network path selection may be performed up to rendezvous node of Net1. That is, when the data owner transmits the packet for intra-network path selecting to the rendezvous node of the Net1 network through AP1, R1 and R2, the rendezvous node may transmit the reply packet for intra-network path selecting back to the terminal through R2, R1 and AP1, thereby selecting the path. In this case, the terminal of Tom who is the data owner is connected to the Net2 network to transmit a packet for path selecting, while moving from the Net1 network to the Net2 network. This packet may be transmitted to the rendezvous node of Net2 through an ICN node including AP2, R4 and R5, and the rendezvous node may confirm that the data owner has moved between networks based on information on the previous network of the packet and information on the current network. Thereafter, the packet for inter-network path selecting may be transmitted to the rendezvous node of the previous network (Net1) and the reply packet for intra-network path selecting may be transmitted back to the data owner through R5, R4 and AP2. The rendezvous node of the previous network (Net1) may receive the packet for inter-network path selecting through a node R5 of the new network and a node R2 of the previous network, and transmit the reply packet for inter-network path selecting back to the rendezvous node of the current network through R2 and R5. In this case, the node R2 of the previous network is involved in both path selection in the Net1 network (path selection to the rendezvous node of Net1 in R2) and path selection between networks (path selection between Net1 and Net2), and the node R5 of the new network may also be an ICN node which is involved in path selection in the current network and path selection between networks. This ICN node may deliver a reply packet for path selection as a packet for path selection is delivered, and may determine which reply packet for path selection is preferentially processed. In an embodiment, in the node R2 located in Net1 which is the previous network, a nexthop set by the reply packet for inter-network path selection has higher priority than other nexthops and, in the node R5 belonging to Net2 which is the newly connected network, the priority of a nexthop set by the reply packet for intra-network path selection shall be higher than that of a nexthop of the reply packet for inter-network path selection.

To this end, according to an embodiment of the present disclosure, a nexthop field may be added to nexthop information in the FIB of the ICN nodes such as R2 and R5, and an inter-network path selection nexthop type (inter-trace nexthop type) set by the reply packet for inter-network path selection (Inter-Trace Data packet) and an intra-network path selection nexthop type (intra-trace nexthop type) set by the reply packet for intra-network path selection (Intra-Trace Data) may be defined. In addition, each path selection prefix (trace prefix) may have less than one inter-network path selection nexthop information (inter-trace nexthop) and less than one intra-network path selection nexthop information (intra-Trace nexthop). In an embodiment, when a reply packet for specific-type path selection is received and the same type of nexthop information is present in the corresponding path selection prefix (trace prefix) in the FIB of the ICN node, it may be overwritten with new nexthop information, that is, a new nexthop interface and timeout value.

In an embodiment, when the reply packet for path selection is received, the ICN node may check a path selection prefix included in the packet. Here, the reply packet for path selection may include a reply packet for intra-network or inter-network path selection as described above. In addition, a reply packet type for path selection (trace data packet type) and a path selection prefix (trace prefix) are parsed based on the received packet, and incoming interface information where a matching packet for path selection is received may be obtained through PIT lookup.

Thereafter, the ICN node may find nexthop information of the path selection prefix from the incoming interface where the packet for path selection obtained by looking up the PIT entry (S602).

In an embodiment, it may be checked whether the received reply packet for path selection is a reply packet for intra-network path selection (S603).

In an embodiment, upon determining that it is not a reply packet for intra-network path selection, that is, upon determining that it is a reply packet for inter-network path selection, it may be checked whether the matching PIT entry has a destination network name (e.g., as a forwarding hint) (S604). Upon determining that the packet does not have the destination network name (e.g., as a forwarding hint), this may mean that the ICN node is located in the previous network of the data owner. Therefore, in this case, it may be necessary to ignore useless intra-network path information (e.g., stale intra-trace type nexthop) that has been previously defined but has not yet timed out. More specifically, based on the path selection prefix, for the FIB entry, an FIB entry may be newly created by setting a nexthop value for inter-network path selection to a new nexthop value or an inter-network path type nexthop may be added to an existing entry or may be updated. In this case, a new timeout value may be assigned, and the priority of the nexthop of the current packet may be set highest (S606). That is, when the reply packet for inter-network path selection has the highest priority, it is possible to ignore useless intra-network path type next hop (stale Intra-Trace type nexthop) information which may exist.

Meanwhile, when the packet is a reply packet for inter-network path selection and has a destination network name (e.g., as a forwarding hint), this may mean that the packet is located in the current network of the data owner or is located in a third-party network which is neither the current network nor the previous network. Accordingly, based on the path selection prefix, for the FIB entry, a nexthop value for inter-network path selection may be added to the FIB as a new nexthop value or updated, a new timeout value may be assigned, the priority of the nexthop may be set lowest (S607). That is, the priority of inter-network path type nexthop (Inter-Trace Type nexthop) may be set lower than that of the intra-network path type nexthop (Intra-Trace type nexthop) to give priority to a currently used intra-network path type next hop (active Intra-Trace type nexthop).

In an embodiment, upon determining that it is a reply packet for intra-network path selection, for the FIB entry of the path selection prefix, an FIB entry may be created by setting the intra-network path type nexthop information to a new nexthop or intra-network path type nexthop may be added to an existing entry or updated and a new timeout value may be assigned. In this case, the priority of the nexthop may be set highest (S605).

Thereafter, a reply packet for path selection may be transmitted based on the incoming interface of the matching PIT entry (S608). Meanwhile, the incoming interface may be an interface where the packet for path selection is received.

Meanwhile, FIG. 6 is also applicable to the packet path selection method of the ICN node of FIG. 12.

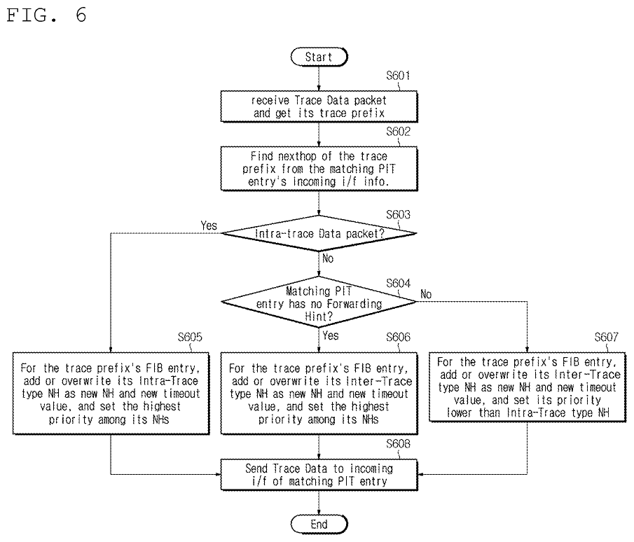

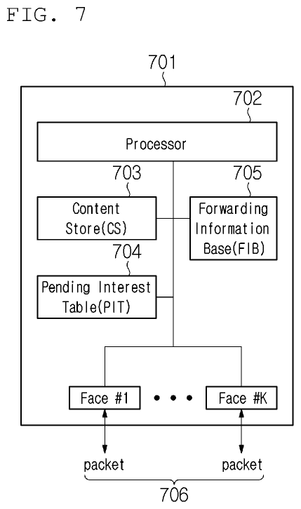

FIG. 7 is a view illustrating a structure of a node in an information-centric network according to an embodiment of the present disclosure, and FIG. 8 is a view illustrating a packet path selecting apparatus in an information-centric network according to an embodiment of the present disclosure.

In an embodiment, prior to description of the structure of the node 701 of FIG. 7 and the apparatus 801 of FIG. 8, the node and the apparatus may perform the packet path selecting method in the information-centric network, which may be based on the packet path selecting method described with reference to FIGS. 3 to 6 and FIGS. 9 to 12.

In an embodiment, the node 701 of FIG. 7 may be an ICN node or a rendezvous node, and may include a processor 702, a content store (CS) 703, a pending interest table (PIT) 704, a forwarding information base (FIB) 705, and one or more interfaces 706.

In an embodiment, the packet path selecting apparatus 801 may be included in an ICN node, a rendezvous node and a terminal, and may include other components in addition to a processor 802 and a transceiver 803 shown in FIG. 8. In addition, since FIG. 8 is shown to describe in detail and clearly the packet path selecting method performed by the packet path selecting apparatus, even if the packet path selecting apparatus is included in a terminal or a node, components (e.g., a processor and an incoming interface) which are already included in the terminal or the node may perform the processor and the transceiver of the packet path selecting apparatus. That is, FIG. 8 only describes the packet path selecting apparatus 801 in order to focus upon the packet path selecting process, which may be included in a node or a terminal or may be a node or terminal itself.

In addition, although not shown in FIG. 7, in an embodiment, the node of FIG. 7 may further include a packet path selecting apparatus, which may have the structure shown in FIG. 8. As another example, since the packet path selecting apparatus is not necessarily configured as a separate apparatus, the node may provide the function provided by the packet path selecting apparatus 801 including the processor 802 and the transceiver 803 by the components shown in FIG. 7 including the processor 702 and the incoming interface 706.

In an embodiment, the processor 702 may correspond to the processor 802 of FIG. 8, perform overall control of the other components 703, 704, 705 and 706 of the node and generate and transmit and receive an interest packet and a data packet through the interface. In an embodiment, the processor may interwork with the other components 703, 704, 705 and 706 and perform a series of processes for packet path selecting. The packet path selecting process may include a process for intra-network path selecting and/or inter-network path selecting, and include those described with reference to other drawings.

Meanwhile, in the case of the rendezvous node having the structure of FIG. 7, based on the processor 702 and the interface 706, the packet for intra-network path selecting may be received from the terminal connected to the network of the rendezvous node, and the reply packet for intra-network path selecting may be transmitted to the terminal. This may correspond to the processor 802 and the transceiver 803 of FIG. 8. In addition, the packet for intra-network path selecting and the packet for inter-network path selecting may include a rendezvous node prefix. The rendezvous node prefix may be advertised to the routing protocol of the network of the rendezvous node. In this case, network movement of the terminal may be determined through comparison between information on the previous network included in the received packet and information on the current network. Upon determining that network movement of the terminal has occurred, the rendezvous node may receive a reply packet for inter-network path selecting from the previous network of the terminal. This will be described in greater detail with reference to FIGS. 10 to 11.

Meanwhile, in the case of the ICN node having the structure of FIG. 7, a packet for path selecting may be delivered between an owner and a data requestor, and a reply packet for path selecting may be delivered between the data owner and the data requestor. In addition, the packet for path selecting may include the packet for intra-network path selecting and the packet for inter-network path selecting according to network movement of the data owner. Upon determining that network movement of the terminal has occurred, the packet for inter-network path selecting may be transmitted to the rendezvous node of the previous network of the terminal. Whether network movement of the data owner has occurred may be determined through comparison between the information on the previous network of the packet for intra-network path selecting and the information on the current network. The reply packet for path selecting may include the reply packet for intra-network path selecting and the reply packet for inter-network path selecting according to network movement of the data owner. The reply packet for intra-network path selecting and the reply packet for inter-network path selecting may be managed as forwarding information base (FIB) entries based on the same path selection prefix (trace prefix), and, when the reply packet for path selecting is a reply packet for inter-network path selecting and there is no matching pending interest table (PIT) entry in the packet, the ICN node may exist in the previous network of the data owner. When the reply packet for path selecting is a reply packet for inter-network path selecting and there is a matching pending interest table (PIT) entry in the packet, the ICN node may exist in the current network of the data owner or a third-party network. Here, the third-party network may be a network which is neither the current network nor the previous network. When the ICN node exists in the previous network of the data owner, the nexthop priority of the reply packet for intra-network path selecting may be lower than that of the reply packet for inter-network path selecting. When the ICN node exists in the current network of the data owner, the nexthop priority of the reply packet for intra-network path selecting may be higher than that of the reply packet for inter-network path selecting. The reply packet for path selecting may be delivered to the incoming interface of the packet for path selecting included in the matching PIT entry. This will be described in greater detail with reference to FIG. 12.

In an embodiment, the content store 703 may perform caching of the data packet which has passed through the corresponding node.

In an embodiment, the PIT 704 may be a table for storing information on the interest packet which has not received a data packet.

In an embodiment, the FIB 705 may be based on a data name prefix and a destination network name (which may be expressed as a forwarding hint), and the node may look up the FIB and forward the interest packet.

In an embodiment, one or more interfaces 706 may transmit and receive the interest packet and the data packet to and from a plurality of remote nodes. In an embodiment, one or more interfaces may correspond to the transceiver 803 of FIG. 8.

Meanwhile, the structure of the node is not limited to the structure of FIG. 7 and some components may be removed or other components may be further included. In addition, functions of several components may be performed by one component and the above-described component does not necessarily perform only the same function.

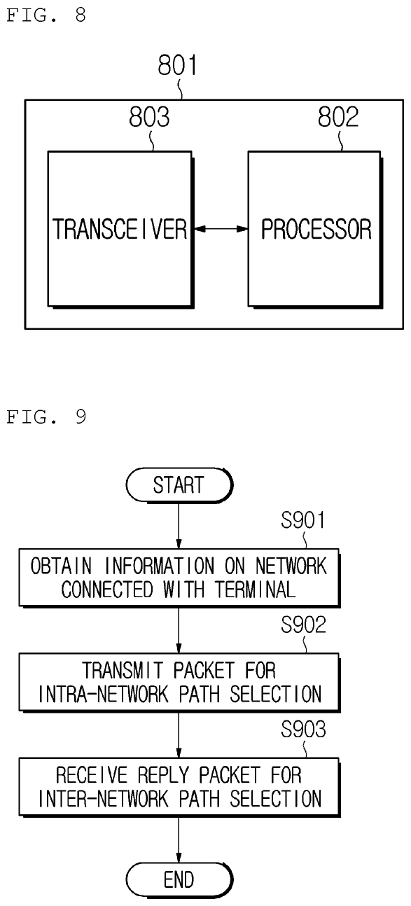

FIG. 9 is a view illustrating a packet path selecting method of a terminal in an information-centric network according to an embodiment of the present disclosure.

In an embodiment, packet path selecting in the information-centric network is based on the method described above with reference to FIGS. 3 to 8, but FIG. 9 illustrates the packet path selecting method performed by the terminal.

In an embodiment, the terminal for performing the method of FIG. 9 may be a terminal of a data owner, and may have the structure of FIG. 8 or may include the packet path selecting apparatus of FIG. 8.

First, the terminal may obtain information on a network to which the terminal is connected (S901). In this case, the network information may include a network name. Accordingly, the terminal may determine to which network the terminal is connected. This may be periodically performed.

Thereafter, the terminal may transmit a packet for intra-network path selecting (S902). This packet may be transmitted to the rendezvous node of the network obtained by the previous step S901, and may be delivered through an ICN node. In addition, this packet may have the packet format described with reference to FIG. 4. The delivery process performed by the ICN node may be described in greater detail with reference to FIG. 12.

Thereafter, the reply packet for intra-network path selecting may be received (S903). This may be transmitted from the rendezvous node of the current network, which has received the packet for intra-network path selecting in the previous step S902, and the packet may be delivered in the reverse direction through all the ICN nodes, through which the packet has passed in the previous step S902. In this case, the packet may have the packet format described with respect to FIG. 4. Accordingly, an intra-network path may be defined between the rendezvous node and the terminal. The defined intra-network path is not fixed even if time passes, and may be changed as the terminal obtains information on the network, to which the terminal is connected, and periodically transmits the packet for intra-network path selecting.

An interest packet and a data packet may be delivered between the data requestor and the data owner according to the intra-network path defined in the above process.

Meanwhile, FIG. 9 shows an embodiment of the present disclosure and the packet path selecting method is not limited thereto and some steps may be omitted or other steps may be added and the order of steps may be changed.

Meanwhile, the connected network information of the terminal may be registered in the name resolution server (NRS) and the data prefix of the terminal, and the connected network information may include the name of the connected network.

In addition, the defined intra-network path may form a path between the data requestor and the data owner along with the intra-network path when network movement of the terminal has occurred. The intra-network path may be defined between rendezvous nodes, which will be described in detail with reference to FIGS. 10 to 11.

FIG. 10 is a view illustrating a packet path selecting method of a rendezvous node in an information-centric network according to an embodiment of the present disclosure, and FIG. 11 is a view illustrating a packet path selecting method of a rendezvous node in an information-centric network according to another embodiment of the present disclosure. More specifically, FIG. 10 is a view illustrating a packet path selecting method performed by the rendezvous node of the current network of the data owner, and FIG. 11 is a view illustrating a packet path selecting method performed by the rendezvous node of the previous network of the data owner.

In an embodiment, packet path selection in the information-centric network is based on the method described with reference to FIGS. 3 to 9, but FIGS. 10 to 11 illustrate the packet path selecting method performed by the rendezvous node.

In an embodiment, the rendezvous node for performing the method of FIGS. 10 to 11 may have the structure of FIG. 7 or FIG. 8 or may include the packet path selecting apparatus of FIG. 8.

In addition, for clarity of description, it is assumed that the rendezvous node of FIGS. 10 to 11 performs packet path selection in the information-centric network with the terminal which is the data owner of FIG. 9 and the ICN node of FIG. 12. However, this is for clarity of description and the present disclosure is not limited thereto. That is, prior to description of the packet path selecting method of FIGS. 10 and 11, it is assumed that the terminal of the data owner obtains information on the network, to which the terminal is connected, and transmits the packet for intra-network path selecting to the rendezvous node of the current network. In this case, the information on the network, to which the terminal is connected, may include the name of the connected network. In an embodiment, this packet may be received by the rendezvous node of FIG. 10 (S1001). The received packet may have the packet format of FIG. 4. Therefore, the rendezvous node may determine whether the terminal of the data owner has moved between networks based on the received packet. In an embodiment, whether the terminal has moved between the networks may be determined by comparing information on the previous network of the received packet with information on the current network.

Thereafter, the rendezvous node of the current network may transmit the reply packet for intra-network path selecting to the terminal (S1002). In an embodiment, this step may be performed regardless of whether the terminal has moved between the networks, and the reply packet may be transmitted in the reverse direction along the packet for intra-network path selecting transmitted by the terminal. That is, the reply packet may be delivered along the same ICN nodes and the order of the ICN nodes may be changed.

Meanwhile, although not shown in FIG. 10, upon determining that the terminal has moved between the networks, the packet for inter-network path selecting may be transmitted to the rendezvous node of the previous network of the terminal. This step may be performed simultaneously with step S1002, before step S1002 or after step S1002. In addition, this may have the packet format of FIG. 4.

In an embodiment, the rendezvous node of the previous network, which has received the packet for inter-network path selecting (S1101), may transmit the reply packet for inter-network path selecting to the rendezvous node of the current network (S1102). In this case, the path of the reply packet for inter-network path selecting may include the ICN nodes included in the path, through which the packet for inter-network path selecting is transmitted, and the traveling direction of the path may be the reverse direction.

When the reply packet for inter-network path selecting is transmitted and is successfully received by the rendezvous node of the current network, an inter-network path for the data owner and the data requestor may be successfully defined.

The defined inter-network path is not fixed even if time passes, and may be changed as the packet for inter-network path selecting is newly transmitted.

An interest packet and a data packet may be delivered between the data requestor and the data owner along the inter-network path defined in the above process.

In addition, in selecting the inter-network path, there may be a third-party network, through which the packet simply passes, in addition to the previous network and the current network, and the same procedure as the rendezvous node of the third-part network may be performed. In an embodiment, when the rendezvous node of the current network transmits the packet for inter-network path selecting to the rendezvous node of the third-part network, the rendezvous node of the third-part network may deliver the packet for inter-network path selecting to the rendezvous node of the previous network through the rendezvous node of the previous network or the rendezvous node of another third-part network.

Meanwhile, FIGS. 10 to 11 show an embodiment of the present disclosure and the packet path selecting method is not limited thereto and some steps may be omitted or other steps may be added and the order of steps may be changed.

FIG. 12 is a view illustrating a packet path selecting method of an ICN node in an information-centric network according to an embodiment of the present disclosure.

In an embodiment, an ICN node capable of performing the packet path selecting method of FIG. 12 may include a pass-through router, an access point, and the like.

In an embodiment, packet path selection in the information-centric network is based on the method described above with reference to FIGS. 3 to 11, but FIG. 12 illustrates the packet path selecting method performed by the ICN node.

In an embodiment, the ICN node for performing the method of FIG. 12 may have the structure of FIG. 7 or 8 or may include the packet path selecting apparatus of FIG. 8.

In addition, for clarity of description, it is assumed that the ICN node of FIG. 12 performs packet path selection in the information-centric network in which the terminal of FIG. 9 exists. However, this is for clarity of description and the present disclosure is not limited thereto. That is, prior to description of the packet path selecting method of FIG. 12, it is assumed that the terminal of the data owner obtains information on the network, to which the terminal is connected, and transmits the packet for intra-network path selecting to the rendezvous node of the current network. In this case, the information on the network, to which the terminal is connected, may include the name of the connected network. Alternatively, it is assumed that network movement of the data owner has occurred and the rendezvous node of the current network transmits the packet for inter-network path selecting to the rendezvous node of the previous network. In this case, the ICN node may exist between the data owner and the rendezvous node and between rendezvous nodes. Therefore, the ICN node may deliver the packet for path selecting between the data owner and the data requestor (S1201). That is, the ICN node may deliver the packet for intra-network path selecting transmitted by the terminal of the data owner or the packet for inter-network path selecting transmitted by the rendezvous node of the current network to a destination, for path selecting between the data owner and the data requestor. In addition, in an embodiment, the destination of the packet for intra-network path selecting may be the rendezvous node of the current network of the data owner, and the destination of the packet for inter-network path selecting may be the rendezvous node of the previous network of the data owner. In addition, such packets may be directly delivered to the destination (e.g., the rendezvous node, etc.) or an ICN node prior to the destination.

Thereafter, when the destination (e.g., the rendezvous node) successfully receives the packet for path selecting between the data owner and the data requestor, the ICN node may deliver a reply packet for path selecting transmitted by the destination to the terminal or the rendezvous node which has transmitted the packet for path selecting (S1202). The reply packet for path selecting may include the reply packet for intra-network path selecting and the reply packet for inter-network path selecting. In addition, such packets may be delivered to the terminal or node which has transmitted the packet for path selecting or another ICN node. In this case, the packet for path selecting and the reply packet for path selecting may be delivered along the same path and only the traveling directions of the path may be different.

Therefore, when the reply packet for intra-network and/or inter-network path selecting is successfully received, path selection may be completed. Based on the defined path, the interest packet of the data requestor and the data packet of the data owner may be transmitted and received.

The defined intra-network and inter-network paths are not fixed even if time passes, and may be changed as the packet for intra-network and inter-network path selection is newly transmitted and delivered.

Meanwhile, the packet for path selection and the reply packet for path selection of FIG. 12 may have the packet format of FIG. 4.

Meanwhile, as described above, the defined inter-network path and the defined intra-network path may have the same path according to network topology. That is, an overlapping path such as passing through the same ICN node may be included. Accordingly, the ICN nodes may adjust the nexthop priorities of the reply packet for intra-network path selecting and the reply packet for inter-network path selecting and create and update the FIB entry, thereby properly delivering the packet. This may be the same as described with reference to FIG. 6.

Meanwhile, FIG. 12 shows an embodiment of the present disclosure and the packet path selecting method is not limited thereto and some steps may be omitted or other steps may be added and the order of steps may be changed.

According to an embodiment of the present disclosure, it is possible to minimize service interruption according to movement of a data producer.

According to an embodiment of the present disclosure, it is possible to provide overhead of advertising a path selection prefix to a routing protocol.

According to an embodiment of the present disclosure, it is possible to support mobility of a data producer according to an intra-network path selection procedure and an inter-network path selection procedure.

It will be appreciated by persons skilled in the art that that the effects that can be achieved through the present disclosure are not limited to what has been particularly described hereinabove and other advantages of the present disclosure will be more clearly understood from the detailed description.

Various embodiments of the present disclosure do not list all possible combinations, but are intended to describe representative aspects of the present disclosure, and matters described in various embodiments may be applied independently or in combination of two or more.

In addition, various embodiments of the present disclosure may be implemented by hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), a general processor, a controller, a microcontroller, a microprocessor, etc. For example, it is apparent that it can be implemented in the form of a program stored in a non-transitory computer-readable medium that can be used at an end or edge, or in the form of a program stored in a non-transitory computer-readable medium that can be used at an edge or in a cloud. do. In addition, it may be implemented by a combination of various hardware and software.

The scope of the present disclosure includes software or machine-executable instructions (e.g., operating system, application, firmware, program, etc.) that cause an operation according to the method of various embodiments to be executed on a device or computer, and non-transitory computer-readable medium in which such software and instructions and the like are stored and executed on a device or computer.

Since various substitutions, modifications and changes of the present disclosure described above are possible within the scope that does not depart from the technical spirit of the present disclosure for those of ordinary skill in the art to which the present disclosure pertains, the scope of the present disclosure is not limited by the above-described embodiments and the accompanying drawings.

What is claimed is:

1. A packet path selecting method performed by a rendezvous node in an information-centric network, the packet path selecting method comprising:
receiving a packet for intra-network path selecting from a producer terminal connected to a network of the rendezvous node; and
transmitting a reply packet for intra-network path selecting to the producer terminal,
wherein, in response to network movement of the producer terminal, transmitting a packet for inter-network path selecting to a rendezvous node of a network previously connected with the producer terminal.

2. The packet path selecting method of claim 1, wherein the packet for intra-network path selecting and the inter-network path selecting include a rendezvous node prefix, and the rendezvous node prefix is the same between all rendezvous nodes.

3. The packet path selecting method of claim 2, wherein the rendezvous node prefix is advertised to a routing protocol of the network of the rendezvous node.

4. The packet path selecting method of claim 1, wherein the received packet includes information on a network previously connected with the producer terminal and information on a currently connected network.

5. The packet path selecting method of claim 4, wherein network movement of the producer terminal is determined by comparing the information on the network previously connected with the producer terminal with the information on the currently connected network.

6. The packet path selecting method of claim 1, further comprising receiving a reply packet for inter-network path selecting from the rendezvous node of the network previously connected with the producer terminal, in response to network movement of the producer terminal.

7. A packet path selecting method performed by a network node in an information-centric network, the packet path selecting method comprising:
delivering a packet for path selecting between a data owner and a data requestor; and
delivering a reply packet for path selecting between the data owner and the data requestor,
wherein the packet for path selecting includes a packet for intra-network path selecting and a packet for inter-network path selecting according to network movement of the data owner.

8. The packet path selecting method of claim 7, wherein the reply packet for path selecting includes a reply packet for intra-network path selecting and a reply packet for inter-network path selecting according to network movement of the data owner.

9. The packet path selecting method of claim 8, wherein the reply packet for intra-network path selecting and the reply packet for inter-network path selecting are respectively given nexthop priorities, and are set as forwarding information base (FIB) entries for a path selection prefix (trace prefix) of the data owner.

10. The packet path selecting method of claim 8, wherein, in response to the reply packet for path selecting which is a reply packet for inter-network path selecting and destination network name not existing in a pending interest table (PIT) entry matching the packet, it is determined that an information-centric network (ICN) node exists in a network previously connected with the data owner.

11. The packet path selecting method of claim 8, wherein, in response to the reply packet for path selecting which is a reply packet for inter-network path selecting and destination network name existing in a pending interest table (PIT) entry matching the packet, it is determined that the network node exists in a network currently connected with the data owner or a third-party network.

12. The packet path selecting method of claim 8, wherein, in response to the network node existing in a network previously connected with the data owner, nexthop priority of the reply packet for intra-network path selecting is lower than that of the reply packet for inter-network path selecting.

13. The packet path selecting method of claim 8, wherein, in response to the network node existing in a current network of the data owner, nexthop priority of the reply packet for intra-network path selecting is higher than that of the reply packet for inter-network path selecting.

14. The packet path selecting method of claim 7, wherein the packet for inter-network path selecting includes a name of a network previously connected with the data owner as a destination network name.

15. The packet path selecting method of claim 7, wherein the packet for intra-network path selecting includes information on a network previously connected with the data owner and information on a network currently connected with the data owner.

16. A packet path selecting method performed by a producer terminal in an information-centric network, the packet path selecting method comprising:
obtaining information on a network connected with the producer terminal;
transmitting a packet for intra-network path selecting to a rendezvous node of a network currently connected with the producer terminal; and
receiving a reply packet for intra-network path selecting from the rendezvous node,
wherein the packet for intra-network path selecting includes information on a network previously connected with the producer terminal and information on a currently connected network.

17. The packet path selecting method of claim 16, wherein the packet for intra-network path selecting includes the same rendezvous node prefix between rendezvous nodes.

18. The packet path selecting method of claim 16, wherein the rendezvous node prefix is advertised to a routing protocol.

19. The packet path selecting method of claim 16, wherein the packet for intra-network path selecting is periodically transmitted.

20. The packet path selecting method of claim 16, wherein network movement of the terminal is updated to a name resolution server (NRS).
